(19) United States
(12) Patent Application Publication
(10) Pub. No.: US 2005/0126893 A1
(43) Pub. Date: Jun. 16, 2005

(54) Device for adjusting the inclination of a vibrating conveyor

(76) Inventor: Hermann Berger, Adenstedt (DE)

Correspondence Address: FRIEDRICH KUEFFNER, 317 MADISON AVENUE, SUITE 910, NEW YORK, NY, 10017, US

(21) Appl. No.: 10/511,519

(22) PCT Filed: Apr. 17, 2002
(86) PCT No.: PCT/EP03/04081

(30) Foreign Application Priority Data
Apr. 19, 2002 (DE) 102 17 604.3

(51) Int. Cl. B65G 27/08

(52) U.S. Cl. 198/763

(57) ABSTRACT

The invention relates to a device for adjusting the inclination of a vibrating conveyor (1) that can be driven by a vibrating drive, in particular for weighing scales for partial quantities, said device comprising a vibrating conveyor support (2) that is located on the vibrating drive. According to the invention, the vibrating conveyor support (2) comprises an abutment (4) and the vibrating conveyor (1) has a manually actuated clamping element (7, 11), which is used to detachably clamp and fix the vibrating conveyor (1) to the abutment (4) at least at two different inclinations.

The invention pertains to a device for adjusting the angle of a vibrating conveyor which can be driven by a vibratory drive, especially for portioning scales, with a vibrating conveyor carrier mounted on the vibratory drive.

A portioning scale or combination scale with this type of vibrating conveyor is described in, for example, DE 3 111 811 C2. In this portioning scale, objects are distributed by a rotating, conical distributor onto vibrating conveyors arranged in a circle underneath the distributor and spaced a certain distance away from it in the radial direction. The vibrating conveyors are set up with a downward slant in the directions pointing away from the distributor and are vibrated by vibratory drives. As a result, the objects supplied to the vibrating conveyors by the distributor are caused to accelerate. Mass forces are thus produced, which help to convey the objects along the vibrating conveyor. The objects are conveyed radially outward in the direction of the downward slant of the vibrating conveyor until they reach the end of the vibrating conveyor, at which point they drop through a collecting hopper into a weighing hopper. The portions of the objects collected via the various vibrating conveyors in the various weighing hoppers are then weighed. It is then determined how the contents of the various weighing hoppers can be combined suitably to result in a previously defined total weight. The combination of the weighing funnel contents thus determined is then sent through a collecting hopper and loaded into a collecting container.

The known device with permanently set angles for the vibrating conveyors suffers from several disadvantages. It functions only for objects with a certain coefficient of friction. Thus, vibrating conveyors set up at relatively small angles are suitable only for the transport of objects with low coefficients of friction such as screws. Objects with greater coefficients of friction, such as edible fruit candies, will not slide along the vibrating conveyor even if the vibrating conveyor is shaken. For this purpose, it would be necessary for the vibrating conveyor to have a greater angle of inclination. But then the objects with a low coefficient of friction would slide down the vibrating conveyor without any shaking at all, an effect which it is desirable to prevent. When work is to be carried out with objects with a different coefficient of friction, the previously known portioning scales set up for objects with a certain coefficient of friction must be reconfigured. This requires a good deal of tedious and difficult mechanical work, if it can be done at all. The angle of a vibrating conveyor is adjusted by loosening the screws which attach it to the vibratory drive, by tilting the vibrating conveyor, and then by tightening the fastening screws again. This adjusting work for reconfiguring the devices for objects with different coefficients of friction, however, is tedious and time-consuming, which means that the unit will be unavailable for production for an extended period of time. The previously known portioning scales are therefore not flexible enough with respect to the demands of production for packaging objects of different types.

In view of these problems of the state of the art, the task of the invention is to provide a device of the type indicated above which can be used flexibly for the packaging of objects with different coefficients of friction.

This task is accomplished according to the invention by the device of the type described above in which the carrier of the vibrating conveyor has an abutment, and the vibrating conveyor has a hand-operated clamping element, by means of which the vibrating conveyor can be tightly but detachably clamped to the abutment at a minimum of two different angles.

This invention is based on the realization that the angle of the vibrating conveyor can be adjusted very quickly to different angles without much effort if the vibrating conveyor can be clamped detachably to an abutment by means of a hand-operated clamping element. For this purpose, it is necessary only to open the clamping element by hand, to adjust the angle of the vibrating conveyor, and finally to clamp the vibrating conveyor firmly back onto the abutment by closing the clamping element. A technician can perform this process in a very short time, whereupon the portioning scale can be put back into service again immediately for loading objects with different coefficients of friction. As a result, the time during which production must cease as a result of the stoppage of the machine during the changeover procedure is reduced to a minimum.

It has been found advantageous according to the invention for the height of the abutment to be adjustable. This represents an especially favorable innovation with respect to engineering design, because a vibrating conveyor which is tightly reclamped to a contact point at a different height will automatically assume a different angle, provided that a second contact point of the vibrating conveyor remains at the same height.

In an effective embodiment, the abutment has a pin, especially a cylindrical pin, which is supported in a first opening in the carrier of the vibrating conveyor. This opening extends essentially in the vertical direction and is located preferably in an upward-projecting area of the carrier. It is also advantageous for the pin to be parallel to the pivot axis of the vibrating conveyor, i.e., the axis around which the vibrating conveyor is turned when its angle is adjusted. The pin, the height of which can be adjusted in the first opening by simple vertical displacement, represents an embodiment of a height-adjustable abutment which is especially favorable from an economic standpoint. Because the pin is parallel to the pivot axis of the vibrating conveyor, the vibrating conveyor can be clamped quite effectively to it. The angle of the vibrating conveyor depends here on the vertical position of the pin in the first opening in the carrier of the vibrating conveyor.

It can also be advantageous for the vibrating conveyor to have a contact element which is complementary to the abutment and which can be used for clamping. When this contact element is clamped to the abutment pin, the vibrating conveyor is connected in an essentially sturdy manner to the carrier.

In an especially advantageous embodiment, a vertically projecting edge of the first opening has at least two recesses, in each of which the pin can rest to establish different height positions. Thus it is ensured, first, that the position to which the abutment has been adjusted is reproducible. That is, each time the pin is set at a certain nominal height, it will be in the same position as it was when previously set to this nominal height. In addition, the recesses prevent the pin from slipping vertically in the first opening in the vibrating conveyor carrier after the vibrating conveyor has been clamped to the abutment.

It has been found advisable according to the invention for the vibrating conveyor carrier, especially the projecting area of the carrier, to have a second opening, which serves to support a tension member of the clamping element, this being the member which introduces the clamping force. This second opening preferably has a horizontal boundary for the tension member in the direction opposite the boundary direction of the edge of the first opening provided with the recesses. This second opening makes it possible for the vibrating conveyor to be clamped tightly to the abutment. In that the tension member is clamped against the horizontal boundary of the second opening, the contact element is pressed against the abutment pin in the direction toward the recesses in the first opening of the vibrating conveyor carrier. As a result, the pin is also pushed into the corresponding recess and thus tightly held in its vertical position. After the tension member of the clamping element has been clamped against the horizontal boundary of the second opening, the angle of the vibrating conveyor is fixed.

In an advantageous embodiment of the invention, the second opening extends essentially in the clamping direction and leads to the outside at the upper edge of the upward-projecting area. Thus, when the clamping element is loosened, the tension member can be lifted up and away from the horizontal boundary of the second opening and thus removed from the upward-projecting area of the vibrating conveyor carrier. This in turn makes it possible to remove the complete vibrating conveyor from the carrier. The second opening preferably has a vertical boundary at the top, which comes to a point at the end leading away from the horizontal boundary. When the removed vibrating conveyor is set back down on the carrier, the pointed area makes it easier to insert the tension member into the second opening, because it acts as a guide rail for the tension member when the tension member is pushed back toward the horizontal boundary.

It has also been found advantageous according to the invention for the vibrating conveyor to have a support element by which it can be supported on the free edge of the upward-projecting area. Thus part of the weight of the vibrating conveyor can be transmitted via the support element to the carrier, and the load on the abutment in the vertical direction can be reduced at the same time. If the support element is located near the center of gravity of the vibrating conveyor, the load on the abutment is reduced to the absolute minimum. The pivot axis around which the vibrating conveyor is rotated when its angle is adjusted passes through the support element.

In an advantageous embodiment of the invention, the clamping element has a tie rod, which is connected to the tension member so that it is parallel to the vibrating conveyor, and a lever arm, which is hinged to the tie rod, the center of rotation of this lever being on the vibrating conveyor. By means of a clamping element designed in this way, it is possible to clamp the vibrating conveyor to the abutment and thus to the carrier in a detachable manner. The lever arm is designed as a manual actuator and is pivoted in such a way that the tension member on the end of the tie rod opposite the manual actuator moves in the clamping direction along the second opening in the carrier. When the clamping element is tightened in the second opening, therefore, the vibrating conveyor is clamped against the abutment. The cylindrical pin of the abutment is pressed into one of the recesses in the first opening of the carrier, as a result of which the height of the pin within the first opening cannot be changed. When attachment of the vibrating conveyor to the carrier is to be loosened, the manual actuator is pivoted in the opposite direction, as a result of which the tie rod is shifted in such a way that its tension member moves away from the clamping position in the second opening. As a result, the vibrating conveyor is no longer pressed against the abutment, and the height of the abutment pin can be adjusted.

The invention is explained below on the basis of the drawing, to which explicit reference is made for all details essential to the invention:

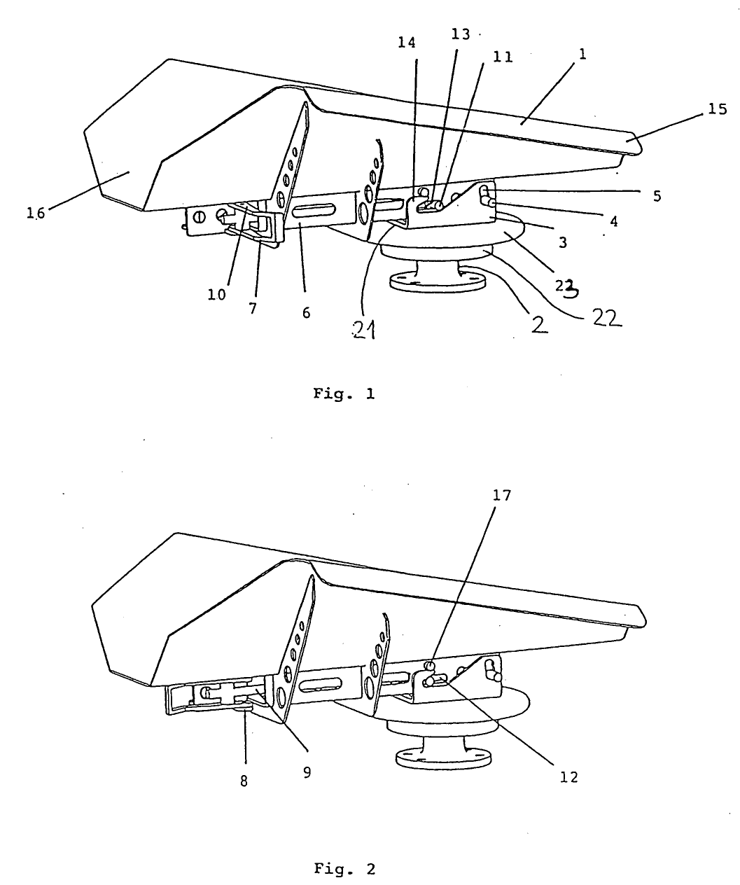

FIG. 1 shows a vibrating conveyor on a device for adjusting the angle of the vibrating conveyor and a vibrating conveyor carrier equipped with a clamping element, where the vibrating conveyor is at an angle of 1° and the clamping element is open;

FIG. 2 shows the vibrating conveyor on a device for adjusting the angle of the vibrating conveyor according to FIG. 1, where the vibrating conveyor is at an angle of 1° and the clamping element is closed;

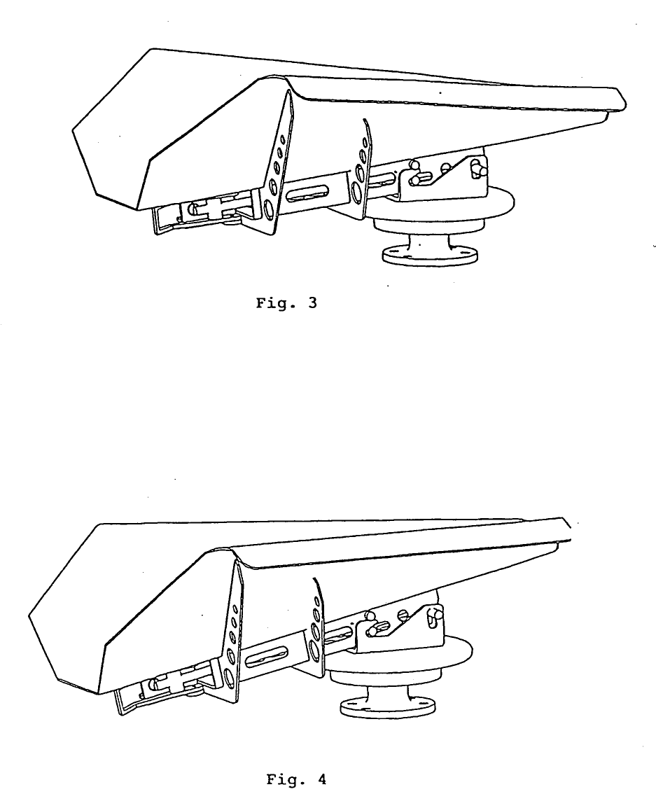

FIG. 3 shows the vibrating conveyor on a device for adjusting the angle of the vibrating conveyor according to FIG. 1, where the vibrating conveyor is at an angle of 6° and the clamping element is closed; and

FIG. 4 shows the vibrating conveyor on a device for adjusting the angle of the vibrating conveyor according to FIG. 1, where the vibrating conveyor is at an angle of 11° and the clamping element is closed.

An embodiment of a device for adjusting the angle of a vibrating conveyor is explained below on the basis of FIG. 1. This shows a vibrating conveyor 1 with a flat bottom piece and two upwardly bent side pieces. The vibrating conveyor is at a slight angle, slanting downward from right to left. Objects which are accepted at the right feed end 15 of the vibrating conveyor 1 can thus be transported in the transport direction, i.e., toward the left discharge end 16. In the transport direction, that is, toward the left, the width of the vibrating conveyor 1 increases continuously. The vibrating conveyor 1 is mounted on a carrier 2, the flange-like lower part of which is fastened by screws to a vibratory drive. The upper part of the vibrating conveyor carrier 2 has a fastening element 3, which allows the carrier to be attached to the vibrating conveyor. This fastening element 3 has a U-shaped cross section with two upward-projecting side walls and a web 21, which connects the side walls. The web 21 of the “U” is tightly clamped by means of threaded bolts (not shown) to an upper radial flange 22 of the carrier 2. In between there is a circular elastic membrane 23, which serves to seal the vibrating conveyor off against the appropriately designed edge of the housing of the portioning scale or some other device equipped with the vibrating conveyor, without interfering with the vibrating movement. A vertical slot 5 to accept an abutment pin 4, designed as a cylindrical rod, is provided in each of the side walls at the end facing the feed end 15 of the vibrating conveyor 1. On the right vertical edge, i.e., the edge closer to the feed end 15 of the vibrating conveyor 1, this slot has three recesses, which conform to the round shape of the abutment pin 4. The abutment pin 4 can thus be held in place at three different heights by pressing it against the recessed edge of the slot. FIGS. 1 and 2 show the abutment pin 4 in the lowermost position; the pin in FIG. 3 occupies the middle position; and in FIG. 4 the pin is in the upper position.

So that the abutment pin 4 will remain reliably in its selected position, nuts (not shown in the drawing) are screwed onto its two free ends, by means of which disk springs placed on the free ends are clamped against the side walls. The abutment pin 4 is thus held reliably and yet adjustably in the vertical direction by the pressure exerted by the disk springs between the abutment pin 4 and the side walls.

The base 6 of the vibrating conveyor is attached to the bottom surface of the flat bottom piece of the vibrating conveyor 1. This base 6 is designed in the form of a hollow tube with a rectangular cross section. It starts at the discharge end 16 of the vibrating conveyor 1 and extends over approximately two-thirds of the length of the vibrating conveyor. Thus, approximately one-third of the length of the vibrating conveyor 1 does not have any of the base 6 under it. At the right end of the base 6, a semicircular opening is provided in each of the two vertical side walls; these openings are designed to support the vibrating conveyor 1 on the abutment pin 4. The part of the base 6 on the left, facing the discharge end 16 of the vibrating conveyor 1, has no front side wall and no bottom piece. A lever-like manual actuator 7, shown in FIG. 2, is attached to the rear side wall by two pivot bearings 8, mounted on an axle. A certain distance away from the axis of rotation of the pivot bearings 8, the end of a tie rod 9 is fastened by way of a pivot bearing 10 to the manual actuator 7. Because parts of the front side wall and bottom wall of the base 6 have been cut away, the manual actuator 7 can be pivoted around an angle of 90° from a closed position, shown in FIG. 2, in which the manual actuator 7 rests against the rear wall of the base 6, to an open position, shown in FIG. 1. As a result of this movement, the tie rod 9 together with a crossbar 11, which is attached at a right angle to the other end of the tie rod and thus serves as the tension member, is shifted in a direction parallel to the orientation of the vibrating conveyor 1. The crossbar 11 passes to the outside through elongated openings 12 provided in the two side walls of the base 6.

FIG. 1 shows the clamping element, comprising the manual actuator 7, the tie rod 9, and the crossbar 11, in the open position. The two ends of the crossbar 11 are located at the entrances to elongated openings 13, one of which is machined into each of the two side walls of the vibrating conveyor fastening element 3. These elongated openings 13 are limited on the left side both horizontally and vertically by a hook-like boundary element 14, which comes to a point at the end directed toward the right. When the manual actuator 7 is now pivoted in the direction toward the closed position shown in FIG. 2, the crossbar 11 is pulled back into the elongated openings 13 until it comes in contact with the hook-like boundary element 14. The vibrating conveyor 1 is thus pushed toward the right and against the abutment pin 4, as a result of which the vibrating conveyor 1 as such is clamped against the abutment pin 4. The weight of the vibrating conveyor is supported on the top surface of the hook-like boundary elements 14 essentially via two knob-like support elements 17, which are formed by the free ends of a continuous transverse bolt passing through the side walls of the base 6, above the elongated openings 12.

To adjust the angle of the vibrating conveyor from the position shown in FIG. 2 with an angle of 1° to the position shown in FIG. 3 with an angle of 6° or to the position shown in FIG. 4 with an angle of 11°, the following steps must be executed. First, the manual actuator 7, as shown in FIG. 1, is pivoted forward, as a result of which the crossbar 11 is pushed toward the right and away from the hook-like boundary element 14. Then the abutment pin 4 is either pushed into the position shown in FIG. 3 in the middle recess or into the position shown in FIG. 4 in the upper recess. The angle of the vibrating conveyor 4, which is seated on the abutment pin 4, is thus shifted accordingly. Finally, the manual actuator 7 must be pivoted back into the closed position, as a result of which the vibrating conveyor 1 is tightly clamped to the carrier 2 in the newly selected position. The vibrating conveyor 1 is pressed against the abutment pin in the direction toward the recesses in the slot 5, as a result of which the abutment pin 4 itself is also pressed into the corresponding recess. This has the effect of clamping the abutment pin 4 in its height-adjusting position.

1. Device for adjusting the angle of a vibrating conveyor (1) driven by a vibratory drive, especially for portioning scales, with a vibrating conveyor carrier (2) mounted on the vibratory drive, and a clamping element, by means of which the vibrating conveyor can be clamped in a detachable manner to an abutment of the vibrating conveyor carrier (2) at a minimum of two different angles, wherein the clamping element has a tension member (11), which is supported on the vibrating conveyor carrier (2) and introduces the clamping force; a tie rod (9) connected to the tension member; and a manual actuating element (7), connected to the tie rod (9), which actuating element can be pivoted manually between a position which loosens the vibrating conveyor (2) and a position which clamps the vibrating conveyor (2).

2. Device according to claim 1, wherein the height of the abutment is adjustable.

3. Device according to claim 1, wherein the abutment has a preferably cylindrical pin, which is supported in an opening (5) in the vibrating conveyor carrier, this opening extending essentially in the vertical direction and being located preferably in an upward-projecting area (3) of the vibrating conveyor carrier.

4. Device according to claim 3, wherein the pin is parallel to the pivot axis of the vibrating conveyor, i.e., the axis around which the vibrating conveyor is oriented when its angle is adjusted.

5. Device according to claim 1, wherein the vibrating conveyor has a contact element which is complementary to the abutment and is used for clamping.

6. Device according to claim 3, wherein a vertical edge of the first opening has at least two recesses, in which the pin can rest to establish different height positions.

7. Device according to claim 3, wherein the vibrating conveyor carrier, especially the projecting area of the vibrating conveyor carrier, has a second opening (13), which serves to support a tension member of the clamping element, namely, the member which introduces the clamping force.

8. Device according to claim 7, wherein the second opening extends essentially in the clamping direction and opens to the outside at the upper edge of the upward-projecting area.

9. Device according to claim 1, wherein the vibrating conveyor has a support element (17), which supports the conveyor on the free edge of the upward-projecting area.

10. Device according to claim 7, wherein the clamping element has a tie rod (9) parallel to the longitudinal axis of the vibrating conveyor, and in that the manual actuator is a lever arm (7), which is hinged to the tie rod and has a center of rotation on the vibrating conveyor (2).
